(19) United States
(12) Patent Application Publication
(10) Pub. No.: US 2010/0315070 A1
(43) Pub. Date: Dec. 16, 2010

(54) INCLINOMETER

(76) Inventor: Wen-Jan Hong, Taoyuan Hsien (TW)

Correspondence Address: CHRISTIE, PARKER & HALE, LLP, PO BOX 7068, PASADENA, CA, 91109-7068, US

(21) Appl. No.: 12/783,296

(22) Filed: May 19, 2010

(30) Foreign Application Priority Data
Jun. 12, 2009 (TW) 098119620

(51) Int. Cl. G01B 7/14; G01C 9/10

(52) U.S. Cl. 324/207.11; 33/365

(57) ABSTRACT

An inclinometer includes a base, a weight, and a magnetic field-detecting unit. The weight is provided with a magnet and is pivotally suspended from the base in such a manner that the base and the weight are rotatable relative to each other. The magnetic field-detecting unit is secured to the base for detecting a magnetic field of the magnet.

### CROSS-REFERENCE TO RELATED APPLICATION

This application claims priority of Taiwanese Application No. 098119620, filed on Jun. 12, 2009, the entire contents of which are incorporated herein by reference.

### BACKGROUND OF THE INVENTION

1. Field of the Invention

This invention relates to an inclinometer, more particularly to an inclinometer having a weight provided with a magnet and a magnetic-field-detecting unit for detecting a magnetic field of the magnet.

2. Description of the Related Art

FIGS. 1 and 2 illustrate a conventional inclinometer that includes a casing 201, a permanent magnet 202, and first and second sensors 26, 27. The casing 201 includes lower and upper casing parts 205, 200. The lower casing part 205 is formed with an L-shaped cavity 204 therein that has first and second sections, each of which has an end 206, 207. The upper casing part 200 is fastened releasably to a top side of the lower casing part 205 and covers the cavity 204. The permanent magnet 202 is disposed movably in the cavity 204 such that the permanent magnet 202 remains at a lowest position by gravity while the inclinometer is inclined. Each of the first and second sensors 26, 27 is mounted on a bottom side of the lower casing part 205 and is disposed at the end 206, 207 of a respective one of the first and second sections of the cavity 204.

The conventional inclinometer is operable to move between first and second inclined positions (not shown). When the conventional inclinometer is disposed at the first inclined position, where the end 206 of first section of the cavity 204 is disposed lower than the end 207 of the second section of the cavity 204 and where the permanent magnet 202 is disposed at the end 206 of the first section of the cavity 204, only the first sensor 26 detects the magnetic field of the permanent magnet 202. On the other hand, when the conventional inclinometer is disposed at the second inclined position, where the end 207 of the second section of the cavity 204 is disposed lower than the end 206 of the first section of the cavity 204 and where the permanent magnet 202 is disposed at the end 207 of the second section of the cavity 204, only the second sensor 27 detects the magnetic field of the permanent magnet 202. As such, by measuring the magnitude of the magnetic field of the permanent magnet 202, the inclining state toward the first inclined position or toward the second inclined position can be determined.

However, in some situations, the permanent magnet 202 of the conventional inclinometer may be affected by an external magnetic field such that the permanent magnet 202 is unable to freely move in the cavity 204 during inclination of the conventional inclinometer. As a consequence, the inclining state of the inclinometer cannot be accurately determined.

### SUMMARY OF THE INVENTION

Therefore, the object of the present invention is to provide an inclinometer.

According to the present invention, an inclinometer comprises: a base; a weight provided with a magnet and pivotally suspended from the base in such a manner that the base and the weight are rotatable relative to each other; and a magnetic field-detecting unit secured to the base for detecting a magnetic field of the magnet.

### BRIEF DESCRIPTION OF THE DRAWINGS

Other features and advantages of the present invention will become apparent in the following detailed description of the preferred embodiments with reference to the accompanying drawings, of which:

FIG. 1 is an exploded perspective view of a conventional inclinometer;

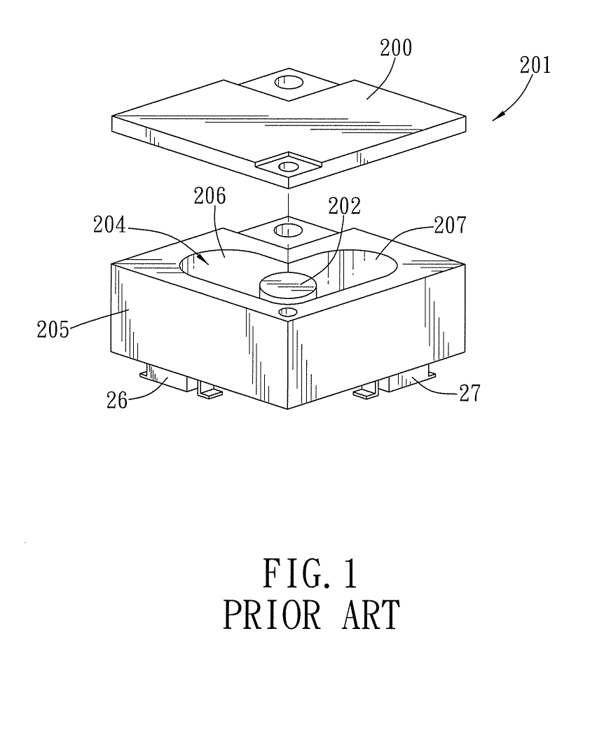

FIG. 2 is a sectional view of the conventional inclinometer;

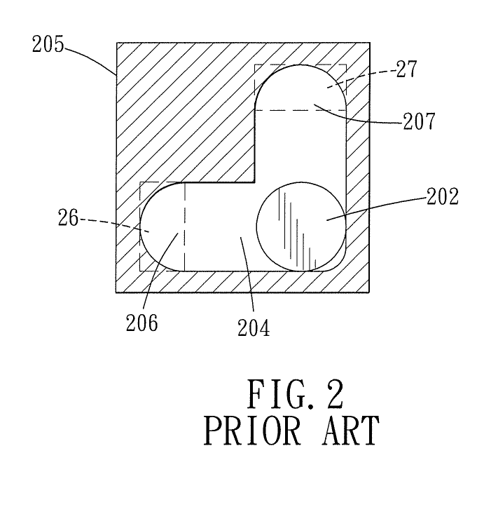

FIG. 3 is an exploded perspective view of the preferred embodiment of an inclinometer according to this invention;

FIG. 4 is a perspective view of the preferred embodiment, illustrating a state where the inclinometer is disposed at a normal position; and

FIG. 5 is a perspective view of the preferred embodiment, illustrating another state where the inclinometer is disposed at an inclined position.

### DETAILED DESCRIPTION OF THE PREFERRED EMBODIMENTS

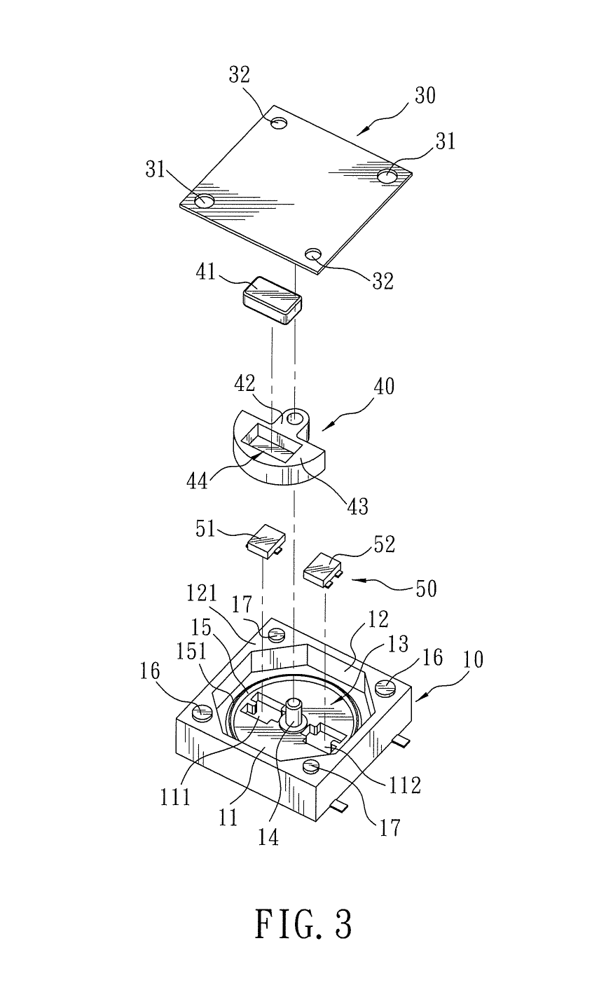

Referring to FIG. 3, the preferred embodiment of an inclinometer according to this invention includes a base 10, a lid 30, a weight 40, and a magnetic field-detecting unit 50.

The base 10 has a first wall portion 11, and a second wall portion 12 extending from the first wall portion 11 in a transverse direction relative to the first wall portion 11 and cooperating with the first wall portion 11 to define a cavity 13. The first wall portion 11 confines one side of the cavity 13. The base 10 is provided with a pivot pin 14 protruding from the first wall portion 11 into the cavity 13 in the transverse direction, and a circumferentially extending flange 15 protruding from the first wall portion 11 into the cavity 13 in the transverse direction and coaxially surrounding the pivot pin 14. In this embodiment, the base 10 is made from a non-magnetic conductive material.

The lid 30 is fastened releasably to the base 10 and covers the cavity 13. The lid 30 is formed with a pair of first holes 31 with a first diameter, and a pair of second holes 32 with a second diameter that is different from the first diameter. The base 10 is further provided with a pair of first protrusions 16 that are formed on a top side 121 of the second wall portion 12, and a pair of second protrusions 17 that are formed on the top side 121 of the second wall portion 12. Each of the first protrusions 16 extends into a respective one of the first holes 31 in the lid 30. Each of the second protrusions 17 extends into a respective one of the second holes 32 in the lid 30. In this embodiment, the lid 30 is made from a non-magnetic conductive material.

The weight 40 is disposed in the cavity 13, and is pivotally suspended from the first wall portion 11 of the base 10 through the pivot pin 14 of the base 10 such that the base 10 and the weight 40 are rotatable relative to each other. The weight 40 is formed with a recess 44, and is provided with a magnet 41 fitted in the recess 44. The magnet 41 is a permanent magnet and is rectangular in shape. In this embodiment, the weight 40 has a linkage 42 and a main body 43 enlarged in size from the linkage 42. The linkage 42 is rod-like in shape and the main body 43 is sector-shaped.

The linkage 42 is pivoted to and extends radially from the pivot pin 14 of the base 10 toward the flange 15 of the base 10. The flange 15 has a distal end 151 that is in sliding contact with the weight 40.

The magnetic field-detecting unit 50 is secured to the base 10 for detecting a magnetic field of the magnet 41. The magnetic field-detecting unit 50 includes two diametrically disposed magnetic field-detecting sensors 51, 52. The first wall portion 11 of the base 10 is formed with two diametrically disposed recesses 111, 112. The magnetic field-detecting sensors 51, 52 are fitted into the recesses 111, 112, respectively. In this embodiment, each of the magnetic field-detecting sensors 51, 52 is a Hall-effect sensor integrated circuit. Alternatively, each of the magnetic field-detecting sensors 51, 52 may be a magneto-resistive sensor or the like. The functions and operations of the magnetic field-detecting sensors 51, 52 are readily appreciated by those skilled in the art. Therefore, further details of the magnetic field-detecting sensors 51, 52 are omitted herein for the sake of brevity.

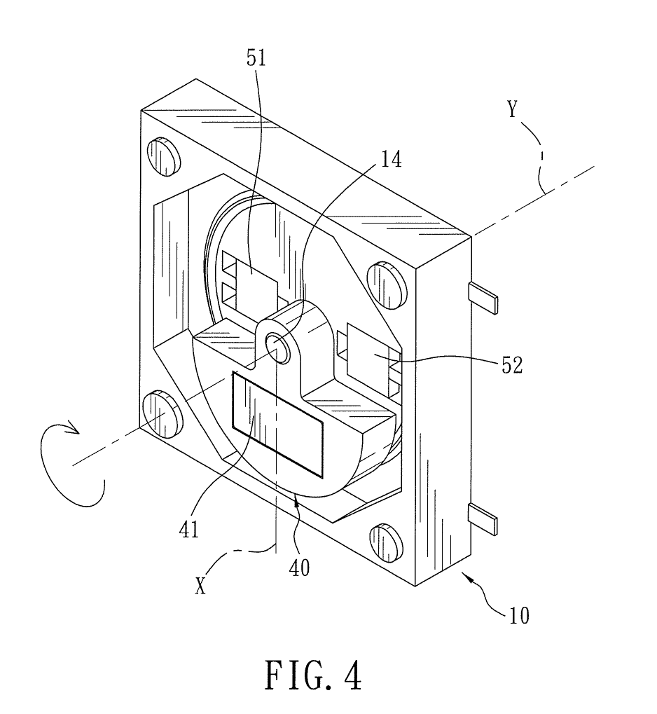

Since the weight 40 is pivotally suspended from the base 10, an axis (X) of the weight (see FIG. 4) is permitted to remain lying on a vertical line directed toward the center of the Earth upon rotation of the base 10 relative to the weight 40.

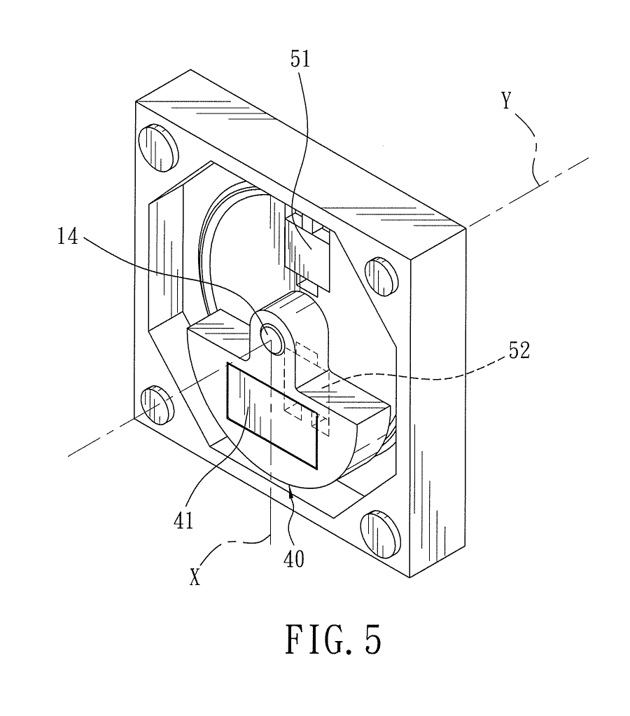

In operation, referring to FIG. 4, when the inclinometer of this embodiment is disposed at a normal position, the magnetic field-detecting sensors 51, 52 are aligned with each other along a horizontal line substantially perpendicular to the vertical line such that neither the magnetic field-detecting sensor 51 nor the magnetic field-detecting sensor 52 detects the magnetic field of the magnet 41. Referring to FIG. 5, when the inclinometer of this embodiment is disposed at an inclined position, i.e., the base 10 rotates about an axis (Y) of the pivot pin 14 relative to the weight to a corresponding position, the magnetic field-detecting sensors 51, 52 are no longer aligned with each other along the horizontal line, and instead, may, for example, be aligned with each other along the vertical line such that the magnet 41 is aligned with the magnetic field-detecting sensor 52 in the transverse direction to permit the magnetic field-detecting sensor 52 to detect the magnetic field of the magnet 41. In some embodiments, the corresponding magnetic-field sensor 51, 52 is able to detect the magnetic field of the magnet 41 when the magnet 41 is only partially aligned with, or in close proximity to, one of the magnetic-field sensors 51, 52.

In sum, since the total weight of the assembly of the magnet 41 and the weight 40 is increased by a considerable amount as compared to the weight of the magnet 202 of the aforesaid conventional inclinometer, the aforesaid affect of an external magnetic field on the magnet 202 as encountered in the prior art can be significantly alleviated. As a result, the assembly of the magnet 41 and the weight 40 is not prevented from moving along with inclination of the inclinometer due to such an affect from an external magnetic field. Ultimately, the inclinometer of the preferred embodiment can provide a more reliable and accurate result for detecting inclination of the inclinometer, even in the presence of an external magnetic field.

While the present invention has been described in connection with what is considered the most practical and preferred embodiment, it is understood that this invention is not limited to the disclosed embodiments but is intended to cover various arrangements included within the spirit and scope of the broadest interpretation so as to encompass all such modifications and equivalent arrangements.

What is claimed is:

1. An inclinometer, comprising:
a base;
a weight provided with a magnet and pivotally suspended from said base in such a manner that said base and said weight are rotatable relative to each other; and
a magnetic field-detecting unit secured to said base for detecting a magnetic field of said magnet.

2. The inclinometer of claim 1, wherein said weight has a linkage and a main body enlarged in size from said linkage, said linkage being pivoted to said base, said main body being sector-shaped.

3. The inclinometer of claim 1, wherein said weight is formed with a recess, said magnet being fitted into said recess in said weight.

4. The inclinometer of claim 1, wherein said base defines a cavity, has a first wall portion confining one side of said cavity, and is provided with a pivot pin that protrudes from said first wall portion into said cavity in a transverse direction relative to said first wall portion, said weight being disposed in said cavity and being pivotally suspended from said first wall portion of said base through said pivot pin.

5. The inclinometer of claim 4, wherein said base is further provided with a circumferentially extending flange that protrudes from said first wall portion of said base in the transverse direction into said cavity and that coaxially surrounds said pivot pin, said flange having a distal end that is in sliding contact with said weight.

6. The inclinometer of claim 5, wherein said weight has a rod-like linkage and a main body enlarged in size from said linkage, said linkage being pivoted to and extending radially from said pivot pin toward said flange, said main body being sector-shaped.

7. The inclinometer of claim 4, wherein said base further has a second wall portion extending from said first wall portion of said base in the transverse direction and cooperating with said first wall portion to define said cavity, said magnetic field-detecting unit including a plurality of magnetic field-detecting sensors, said first wall portion of said base being formed with a plurality of recesses, said magnetic field-detecting sensors being fitted into said recesses, respectively, said magnet being at least partially aligned with one of said magnetic field-detecting sensors in the transverse direction when said base rotates about an axis of said pivot pin relative to said weight to a corresponding position.
